(19) United States
(12) Patent Application Publication
(10) Pub. No.: US 2003/0103010 A1
(43) Pub. Date: Jun. 5, 2003

(54) Dual-band antenna arrangement

(75) Inventor: Kevin R. Boyle, Horsham (GB)

Correspondence Address: Corporate Patent Counsel, U.S. Philips Corporation, 580 White Plains Road, Tarrytown, NJ, 10591, US

(73) Assignee: KONINKLIJKE PHILIPS ELECTRONICS.

(21) Appl. No.: 10/302,352

(22) Filed: Nov. 22, 2002

(30) Foreign Application Priority Data
Nov. 28, 2001 (GB) 0128418.1

(51) Int. Cl. H01Q 1/24

(52) U.S. Cl. 343/702; 343/700 MS; 343/846

(57) ABSTRACT

A dual-band antenna arrangement comprises an antenna (102,104) connected to a first feed conductor (106a) for signals in a first frequency band, a second feed conductor (106b) for signals in a second frequency band and a ground conductor (108). First and second transmission lines are formed by the ground conductor and a respective one of the feed conductors, and each of the transmission lines has its length optimised to be used in conjunction with a respective complementary circuit element thereby enabling a good match to the antenna to be achieved in each of the frequency bands.

In one embodiment the antenna is a PIFA, and the lengths of the transmission lines are optimised by the addition of a linking conductor (910) between the feed and ground conductors, thereby enabling the use of larger shunt capacitances as the circuit elements, improving bandwidth and Q.

The present invention relates to a dual-band antenna arrangement comprising a substantially planar patch conductor, and to a radio communications apparatus incorporating such an arrangement. In the present specification, the term dual-band antenna relates to an antenna which functions satisfactorily in two (or more) separate frequency bands but not in the unused spectrum between the bands.

Wireless terminals, such as mobile phone handsets, typically incorporate either an external antenna, such as a normal mode helix or meander line antenna, or an internal antenna, such as a Planar Inverted-F Antenna (PIFA) or similar.

Such antennas are small (relative to a wavelength) and therefore, owing to the fundamental limits of small antennas, narrowband. However, cellular radio communication systems typically have a fractional bandwidth of 10% or more. To achieve such a bandwidth from a PIFA for example requires a considerable volume, there being a direct relationship between the bandwidth of a patch antenna and its volume, but such a volume is not readily available with the current trends towards small handsets. Further, PIFAs become reactive at resonance as the patch height is increased, which is necessary to improve bandwidth.

International patent application WO 01/37369 discloses a PIFA in which matching is achieved by linking feed and shorting pins with a conductive matching element whose dimensions are chosen to provide a suitable impedance match to the antenna. Such an antenna is inherently narrowband.

European patent application EP 0,867,967 discloses a PIFA in which the feed pin is meandered to increase its length, thereby increasing its inductance in an attempt to make the antenna easier to match. A broadband match is difficult to achieve with such an antenna, requiring a small matching capacitance.

Our co-pending unpublished International patent application PCT/IB02/02575 (Applicant's reference PHGB 010120) discloses an improvement to a conventional PIFA in which a conductor linking feed and shorting pins is provided which reduces the inductive impedance of the antenna and therefore increases the required shunt matching capacitance. This arrangement improves bandwidth, in contrast to the arrangement disclosed in WO 01/37369.

Our co-pending International patent application WO 02/060005 (Applicant's reference PHGB 010009) discloses a variation on a conventional PIFA in which a slot is introduced in the PIFA between the feed pin and shorting pin. Such an arrangement provided an antenna having substantially improved impedance characteristics while requiring a smaller volume than a conventional PIFA.

An object of the present invention is to provide an improved antenna arrangement.

According to a first aspect of the present invention there is provided a dual-band antenna arrangement comprising an antenna connected to a first feed conductor for signals in a first frequency band, a second feed conductor for signals in a second frequency band and a ground conductor, wherein first and second transmission lines are formed by the ground conductor and a respective one of the feed conductors, and wherein each of the transmission lines has its length optimised to be used in conjunction with a respective complementary circuit element thereby enabling a good match to the antenna to be achieved in each of the frequency bands.

A wide range of monopole-like antennas may be used with the present invention, including PIFAs, Printed Wire Antennas (PWAs) and helical antennas.

In a preferred embodiment of the present invention, the antenna is a PIFA comprising a substantially planar patch conductor, the first feed conductor comprises a first feed pin connected to the patch conductor at a first point, the second feed conductor comprises a second feed pin connected to the patch conductor at a second point, and the ground conductor comprises a ground pin connected between a third point on the patch conductor and a ground plane. The first and second transmission lines are short circuit transmission lines whose respective lengths are defined by a first linking conductor connecting the first feed and ground pins and a second linking conductor connecting the second feed and ground pins, and the complementary circuit elements comprise first and second shunt capacitance means coupled respectively between the first and second feed pins and the ground pin.

The presence of the linking conductors acts to reduce the length of the short circuit transmission lines formed by each of the feed pins and the ground pin, and hence their inductance, enabling the value of the shunt capacitances to be increased which provides improved bandwidth. The linking conductors may also be connected to the patch conductor, or there may be gaps between the pins both above and below the linking conductors. By arranging for the matching inductance to be provided as part of the antenna structure, the inductance has a higher Q than that provided by circuit solutions at no additional cost.

The feed and ground pins may have different cross-sectional areas, to provide an impedance transformation. Alternatively, or in addition, one or more of the feed and ground pins may be formed of a plurality of conductors to provide an impedance transformation. The impedance transformation may also be provided by a slot or slots in the patch conductor between one or both of the feed pins and the ground pin, as disclosed in WO 02/060005.

According to a second aspect of the present invention there is provided a radio communications apparatus including an antenna arrangement made in accordance with the present invention.

Embodiments of the present invention will now be described, by way of example, with reference to the accompanying drawings, wherein:

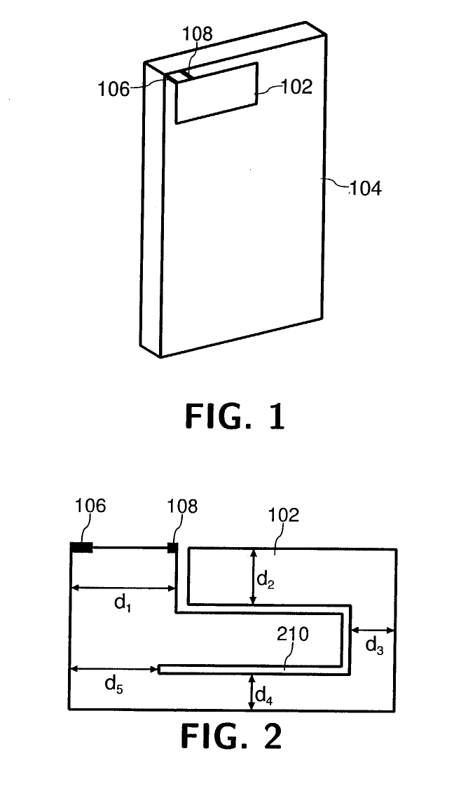

FIG. 1 is a perspective view of a PIFA mounted on a handset;

FIG. 2 is a plan view of a dual-band PIFA patch conductor;

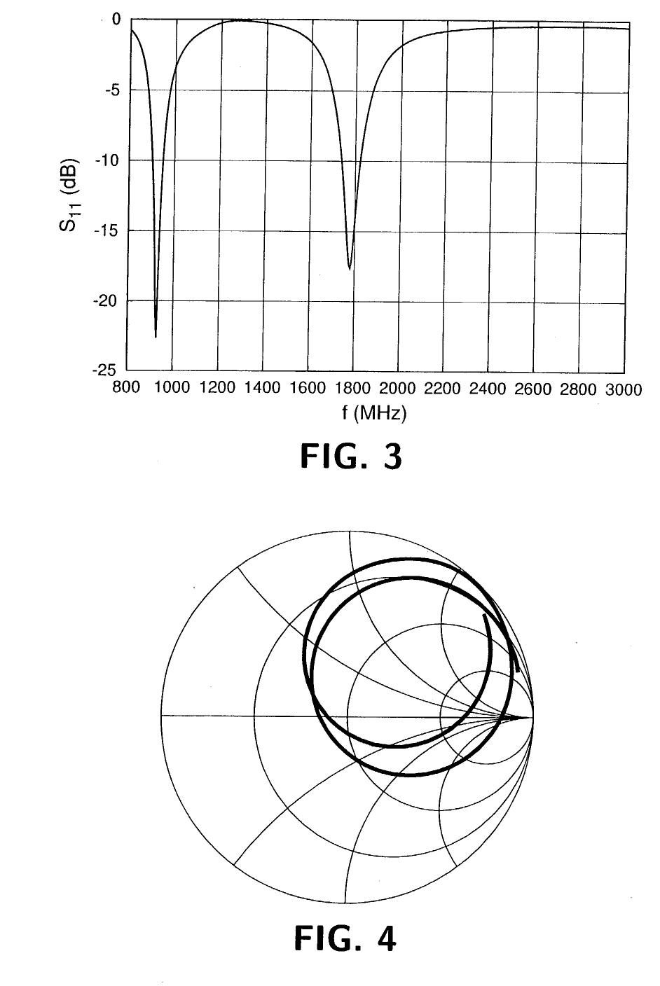

FIG. 3 is a graph of simulated return loss S₁₁ in dB against frequency in MHz for the antenna of FIG. 2;

FIG. 4 is a Smith chart showing the simulated impedance of the antenna of FIG. 2 over the frequency range 800 to 3000 MHz;

FIG. 5 is a circuit diagram of a conventional dual-band matching circuit for use with the PIFA of FIG. 2;

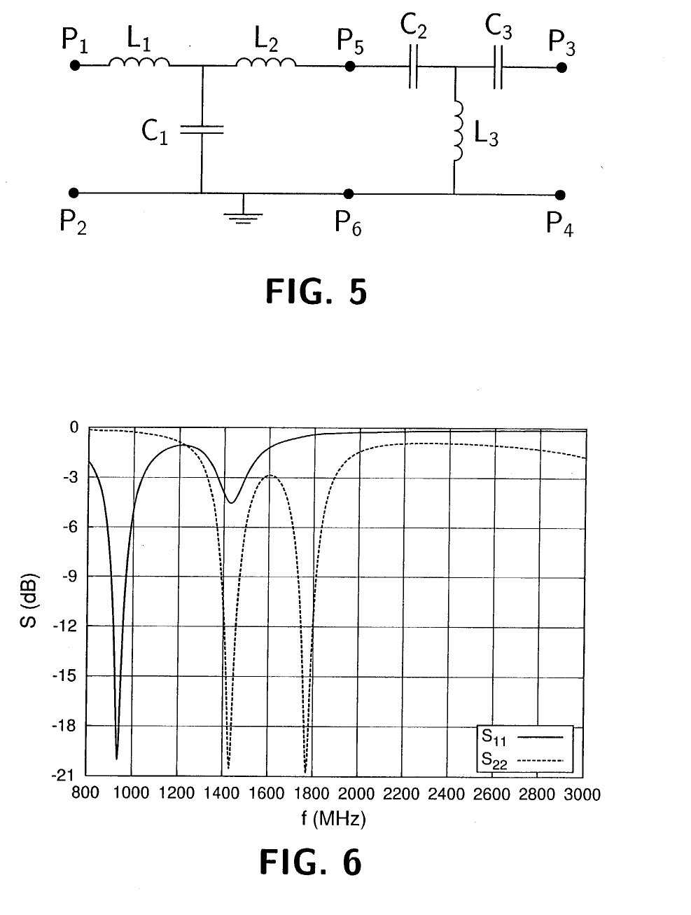

FIG. 6 is a graph of simulated return loss S₁₁ in dB against frequency f in MHz for the PIFA of FIG. 2 driven via the matching circuit of FIG. 5;

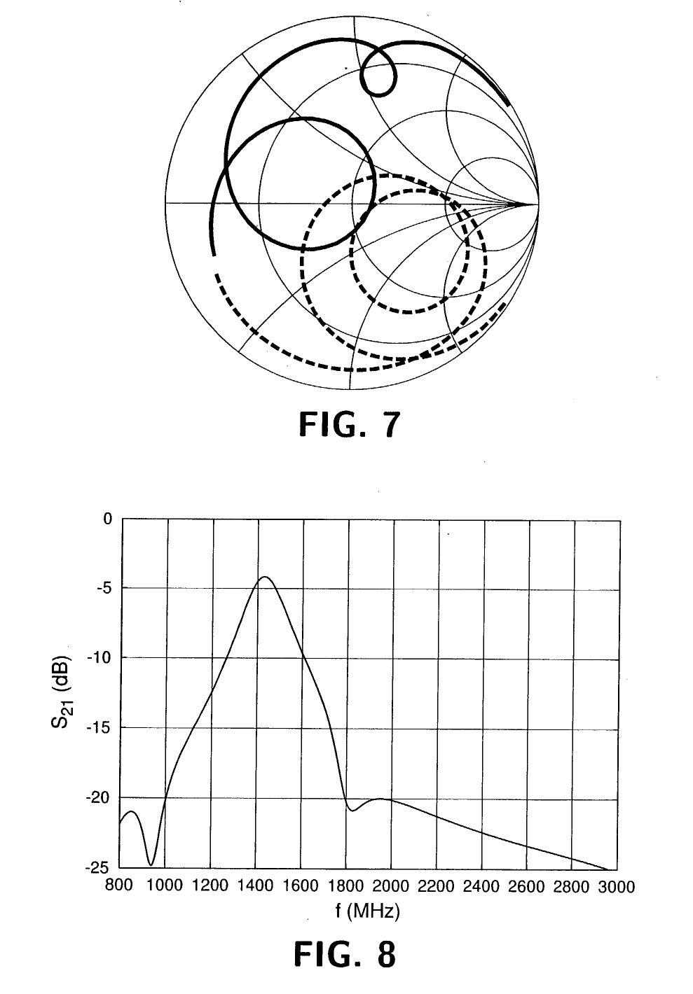

FIG. 7 is a Smith chart showing the simulated impedance of the PIFA of FIG. 2 over the frequency range 800 to 3000 MHz driven via the matching circuit of FIG. 5;

FIG. 8 is a graph of isolation between feeds S₂₁ in dB against frequency f in MHz for the PIFA of FIG. 2 driven via the matching circuit of FIG. 5;

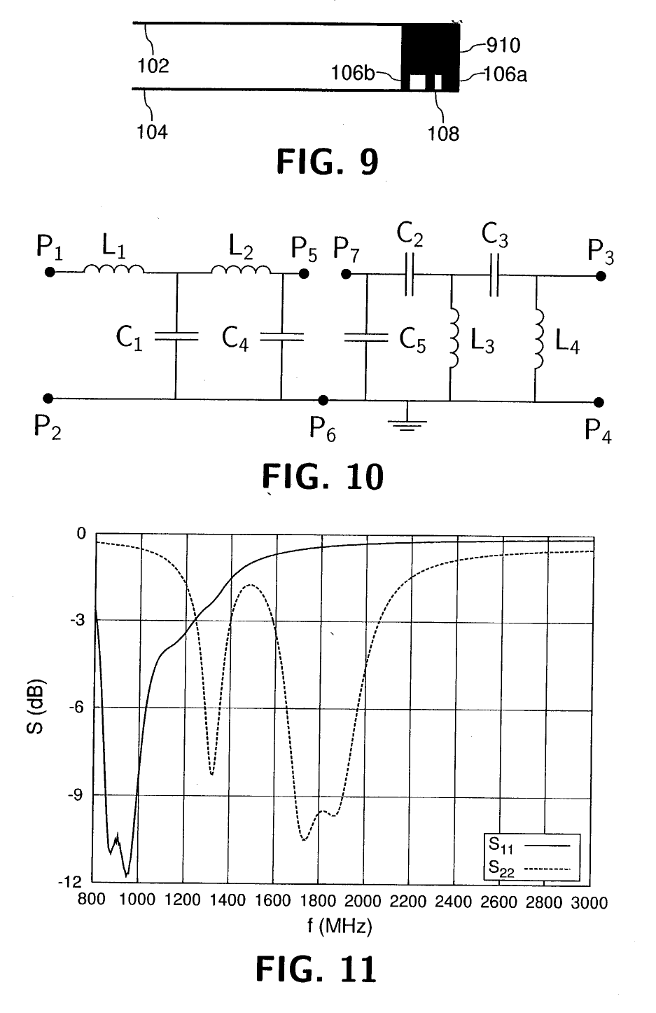

FIG. 9 is a side view of an PIFA feed arrangement made in accordance with the present invention;

FIG. 10 is a circuit diagram of a dual-band matching circuit for use with the PIFA of FIG. 9;

FIG. 11 is a graph of simulated return loss S₁₁ in dB against frequency f in MHz for the PIFA of FIG. 9 driven via the matching circuit of FIG. 10;

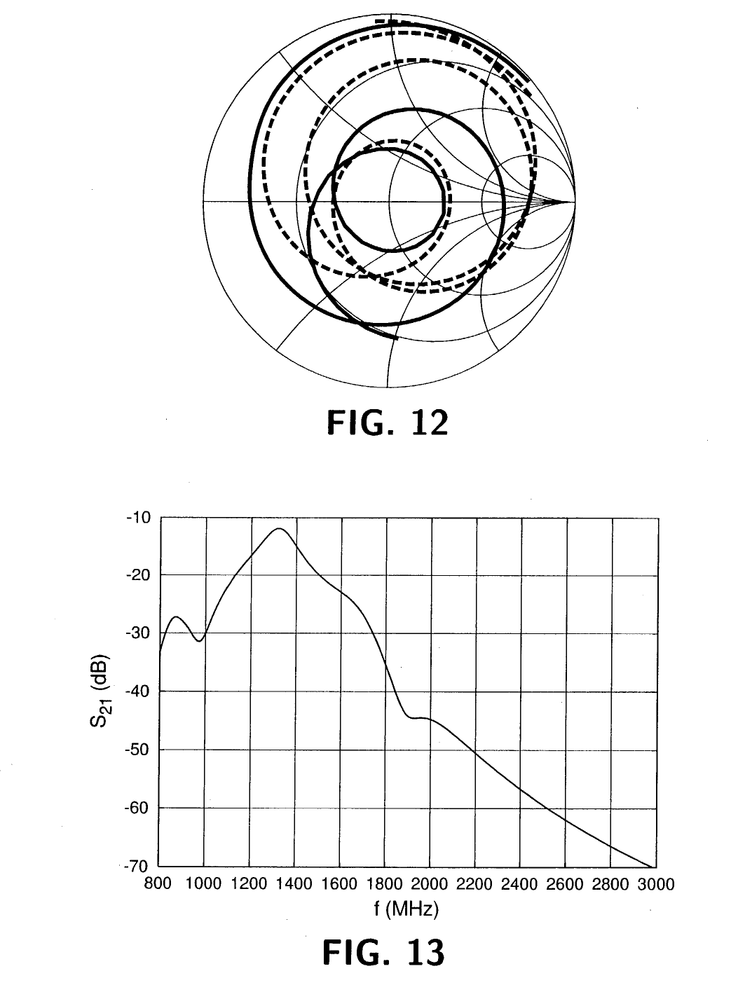

FIG. 12 is a Smith chart showing the simulated impedance of the PIFA of FIG. 9 over the frequency range 800 to 3000 MHz driven via the matching circuit of FIG. 10;

FIG. 13 is a graph of isolation between feeds S₂₁ in dB against frequency f in MHz for the PIFA of FIG. 9 driven via the matching circuit of FIG. 10;

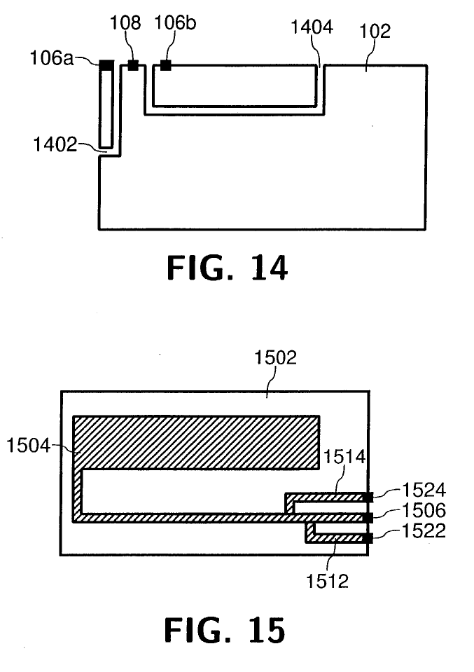

FIG. 14 is a plan view of of a dual-band PIFA patch conductor suitable for feeding via open-circuit transmission lines; and

FIG. 15 is a plan view of of a dual-band PWA arrangement made in accordance with the present invention.

In the drawings the same reference numerals have been used to indicate corresponding features.

A perspective view of a single-band PIFA mounted on a handset is shown in FIG. 1. The PIFA comprises a rectangular patch conductor 102 supported parallel to a ground plane 104 forming part of the handset. The antenna is fed via a feed pin 106, and connected to the ground plane 104 by a shorting pin 108 (also known as a ground pin). The feed and shorting pins are typically parallel for convenience of construction, but this is not essential for the functioning of the antenna.

In a typical example embodiment of a dual-band PIFA, for use in GSM and DCS frequency bands, the patch conductor 102 has dimensions 40×20 mm (larger than the single-band PIFA shown in FIG. 1) and is located 8 mm above the ground plane 104 which measures 40×100×1 mm. The feed pin 106 is a planar conductor with a width of 2.5 mm located at a corner of both the patch conductor 102 and ground plane 104, the shorting pin 108 is a planar conductor with a width of 1 mm separated from the feed pin 106 by 9.5 mm. The difference in the widths of the pins 106,108 provides an impedance transformation, as discussed below, while the separation of the pins 106,108 reduces the inductive impedance of the short-circuit transmission line formed by the pins and the patch conductor 102.

FIG. 2 is a plan view of the patch conductor 102, which incorporates a slot 210. The slot can be considered as dividing the patch conductor 102 into two antennas connected to a common feed, namely a smaller central radiator for the DCS frequency band and a longer radiator, wrapped around the central radiator, for GSM. The first section of the slot has a width of 1.5 mm, the remaining three sections have a width of 1 mm. The slot position is defined by the five dimensions d₁ to d₅ shown in FIG. 2, where d₁ is 13 mm, d₂ is 7 mm, d₃ is 5.5 mm, d₄ is 4.5 mm and d₅ is 11 mm.

It is well known that the impedance of a PIFA is inductive. One explanation for this is provided by considering the currents on the feed and shorting pins 106,108 as the sum of differential mode (equal and oppositely directed, non-radiating) and common mode (equally directed, radiating) currents. For the differential mode currents, the feed and shorting pins 106,108 form a short-circuit transmission line, which has an inductive reactance because of its very short length relative to a wavelength (8 mm, or 0.05λ at 2 GHz, in the embodiment shown in FIG. 2). This inductive reactance acts like a shunt inductance across the antenna feed. In order to match to the antenna 102, shunt capacitance needs to be provided between the feed and shorting pins 106,108 to tune out the inductance by resonating with it at the resonant frequency of the antenna. Although this can be provided by a shunt capacitor, in known PIFAs it is typically provided by modifying the antenna geometry. For example, this may be done by extending the patch conductor 102 towards the ground plane 104 close to the feed pin 106 to provide some additional capacitance to ground.

The return loss S₁₁ of the combined antenna 102 and ground plane 104 shown in FIG. 2 was simulated using the High Frequency Structure Simulator (HFSS), available from Ansoft Corporation. When fed directly from a 50 Ω source impedance, the results are shown in FIG. 3 for frequencies f between 800 and 3000 MHz. A Smith chart illustrating the simulated impedance over the same frequency range is shown in FIG. 4.

This antenna arrangement has high radiation efficiency (close to 100%) with a return loss of 5 dB or better over the GSM (880-960 MHz) and DCS (1710-1880 MHz). However, in a practical application the antenna needs to be fed via a diplexer, to provide isolation between GSM and DCS circuitry and thereby ensure that power intended for radiation by the GSM circuitry is not absorbed by the DCS circuitry and vice-versa. Because the antenna is not designed in sympathy with the diplexer, the VSWR to the antenna is often degraded at the inputs to the diplexer. Similarly, the diplexer isolation and filtering are often degraded by the mismatch presented by the antenna, since they are nominally designed to operate with a constant output impedance.

A circuit diagram of a conventional diplexer suitable for driving the PIFA of FIG. 2 is shown in FIG. 5, where the components used have the following values: L₁ is 10 nH; L₂ is 11 nH; C₁ is 3.5 pF; C₂ and C₃ are 1 pF; and L₃ is 5 nH. GSM circuitry having a 50 Ω source impedance is connected between P₁ and P₂, DCS circuitry having a 50 Ω source impedance is connected between P₃ and P₄, P₅ is connected to the feed pin 106, and P₆ is connected to the ground plane 104 (or equivalently the shorting pin 108). The GSM part of the diplexer comprises a low pass filter (L₁, L₂ and C₁), while the DCS part comprises a high pass filter (C₂, C₃ and L₃).

Simulations of the combined antenna 102 and ground plane 104, fed via this diplexer, were performed. FIG. 6 illustrates the return loss for frequencies f between 800 and 3000 MHz, where S₁₁, shown as a solid line, relates to return loss for signals fed across P₁ and P₂ and S₂₂, shown as a dashed line, relates to return loss for signals fed across P₃ and P₄. Return loss is degraded in some areas compared to that without the diplexer, for example being only 3.3 dB at 1880 MHz at the upper edge of the DCS band. A Smith chart showing the simulated impedances (with S₁₁ as a solid line and S₂₂, shown as a dashed line) is shown in FIG. 7.

FIG. 8 illustrates the isolation S₂₁ between the GSM and DCS feeds. There is isolation of about 20 dB in the GSM and DCS bands, which is generally acceptable although more isolation would increase the power radiated for a given input power.

An antenna arrangement made in accordance with the present invention provides improved matching and isolation for a dual-band antenna. It was shown in our co-pending unpublished International patent application PCT/IB02/02575 (Applicant's reference PHGB 010120) that the bandwidth of a PIFA can be significantly improved if the shunt inductance of the transmission line formed by the feed and shorting pins 106,108 were reduced and the value of the shunt capacitor increased. This is because, as a first approximation, the antenna 102 looks like a series resonant LCR circuit with substantially constant resistance. Such a circuit is best broadbanded by a complementary parallel LC circuit. Reducing the inductance of the parallel circuit (provided by the short circuit transmission line) and increasing the capacitance provides a response which complements the antenna response better and is therefore more effective at improving bandwidth. This was done by adding a linking conductor between the feed and shorting pins 106,108, thereby reducing the length of the transmission line.

FIG. 9 shows a side view of an embodiment of an improved feeding arrangement in accordance with the present invention. The patch conductor 102 is similar to that shown in FIG. 2, with the modifications that the width of the first part of the slot 210 is increased to 2 mm and d₃ and d₄ are each increased to 6 mm. First 106a and second 106b feed pins are provided, together with a shorting pin 108. A linking conductor 910 is provided which connects the feed and shorting pins 106,108 together over most of their length. As shown in FIG. 9 the linking conductor connects the feed and shorting pins 106a,106b,108 from the points at which they contact the patch conductor 102 and is therefore also connected to the patch conductor 102.

However, this arrangement is not essential and in alternative embodiments there could be a gap between the pins 106a,106b,108 both above and below the linking conductor 910. This is because the linking conductor provides a path between the pins 106a,106b,108 for differential mode current while having minimal effect on the common mode current. Hence, providing the linking conductor 910 has sufficient height to form (together with one of the feed pins 106a, 106b and the shorting pin 108) a short circuit transmission line, it is not necessary for it to continue as far as the patch conductor and the linking conductor 910 could simply comprise a thin strap. Further, there is no need for the dimensions of the linking conductor between the first feed pin 106a and the shorting pin 108 to be the same as that between the second feed pin 106b and the shorting pin.

The impedance to which the antenna is matched can be changed by altering the relative thicknesses of the feed and shorting pins 106a,106b,108, as discussed in our-co-pending International patent application WO 02/060005 (Applicant's reference PHGB010009). This is because the common mode current is the sum of the currents in one of the feed pins 106a,106b and the shorting pin 108, so by altering their relative thicknesses (and hence impedances) the ratio of current between the pins can be varied. For example, if the cross-sectional area of the shorting pin 108 is increased, reducing its impedance, the common mode current on the first or second feed pin 106a,106b will be reduced and the effective impedance of the antenna will be increased. Such an effect could also be achieved by replacing one or more of the feed and shorting pins 106a,106b,108 by a plurality of conductors connected in parallel, or by a combination of the two approaches.

In the feeding arrangement shown in FIG. 9, the first feed pin 106a is planar with a width of 2 mm while the second feed pin 106b and the shorting pin 108 are planar with a width of 1 mm, with a gap of 1 mm between the first feed and shorting pins 106a,108 and a gap of 2 mm between the second feed and shorting pins 106b,108. The linking conductor 910 extends from the patch conductor 102 to 2 mm from the ground conductor 104. Hence, the common-mode impedance transformation is different for the two bands, which is a major advantage of an antenna arrangement made in accordance with the present invention. The inductance of the respective short-circuit transmission lines formed by the first and second feed pins 106a,106b and the shorting pin 108 is tuned by respective shunt capacitors. Since the feeds are independent each capacitance can be independently optimised, which results in more wideband performance for both bands with no compromise between the bands, unlike a conventional PIFA.

An impedance transformation could also be arranged by the provision of a slot or slots in the patch conductor 102 between one or both of the feed pins 106a,106b and the shorting pin 108, as disclosed in WO 02/060005. By arranging the slot or slots asymmetrically in the patch conductor the relative currents carried by the feed and shorting pins 106a,106b,108 can be varied since the patch conductor 102 then appears as a short-circuit two-conductor transmission line having conductors of different dimensions. In a mobile phone embodiment, where the patch conductor 102 could be printed on an internal surface of the phone casing, such an arrangement has the advantage of enabling a range of antenna impedances to be provided by different patch conductor configurations while using common feed and ground pins 106a,106b,108 (which could be provided as sprung contacts).

To prevent energy from being transferred between the feeds 106a,106b a split diplexer is implemented, the circuit for which is shown in FIG. 10. The components used have the following values: L₁ is 8 nH; L₂ is 11 nH; C₁ is 3.5 pF; C₂ is 1 pF, C₃ is 1.1 pF; L₃ is 5 nH; L₄ is 7 nH; C₄ is 14.5 pF and C₅ is 2.7 pF. GSM circuitry having a 50 Ω source impedance is connected between P₁ and P₂, DCS circuitry having a 50 Ω source impedance is connected between P₃ and P₄. P₅ is connected to the first feed pin 106a, P₇ is connected to the second feed pin 106b, and P₆ is connected to the ground plane 104 (or equivalently the shorting pin 108).

The low pass and high pass filter components of the diplexer are similar to the conventional diplexer shown in FIG. 5. In addition the diplexer comprises shunt capacitors C₄ and C₅, which resonate with the antenna inductance (provided by the short circuit transmission lines) to provide a combined matching and broadbanding function. The DCS matching capacitor, C₅, is much smaller than the GSM matching capacitor, C₄, although this can be varied to some extent depending on the gap between the second feed pin 106b and the shorting pin 108. The DCS circuitry also comprises an additional matching inductor L₄, which could be avoided with some modifications to the antenna structure.

Simulations of the combined antenna 102 and ground plane 104, fed via this diplexer, were performed. FIG. 11 illustrates the return loss for frequencies f between 800 and 3000 MHz, where S₁₁ shown as a solid line, relates to return loss for signals fed across P₁ and P₂ and S₂₂, shown as a dashed line, relates to return loss for signals fed across P₃ and P₄. Return loss is significantly improved compared to the conventional results in FIGS. 3 and 6. In the GSM band the return loss is better than 10 dB over a bandwidth greater than that required, while a return loss of close to 10 dB is achieved over the entire DCS band. The volume of this antenna and the conventional antenna shown in FIG. 2 are identical and, apart from the feeding arrangement, the structures have only minor differences. A Smith chart showing the simulated impedances (with S₁₁ as a solid line and S₂₂, shown as a dashed line) is shown in FIG. 12.

The additional bandwidth provided by the dual-fed structure allows either better return loss performance, or the same performance as a conventional antenna but over a wider bandwidth. It appears feasible that the structure described above could, with only minor modifications, cover four bands (IS-95, EGSM, DCS and PCS) with a return loss of better than 6 dB. Alternatively, the antenna could be made smaller while maintaining acceptable performance.

FIG. 13 illustrates the isolation S₂₁ between the GSM and DCS feeds. It can be seen that isolation is considerably improved over the conventional diplexer, being approximately 29 dB at the centre of the GSM band and 35 dB at the centre of the DCS band.

The dual-fed structure also means that the antenna will inherently filter spurious emissions from radio transceivers better. For example, the GSM feed to a conventional antenna will also be well matched at DCS, which means that the second harmonic of GSM will not be filtered out by the antenna. In the dual-fed configuration described above, the GSM feed will be poorly matched at DCS and the antenna will be more effective at filtering harmonics. This will permit the filtering requirements of the RF front-end in a transceiver to be relaxed, with resultant cost savings.

Although described in detail above with reference to a PIFA, the present invention has much wider applicability and can be used with any monopole-like antenna arrangement where the antenna feed arrangement can be considered as comprising two transmission lines and where the lengths of the transmission lines are selected so that the transmission line impedances can be used in conjunction with complementary circuit elements, thereby providing broader bandwidth and better filtering. (A PIFA may be considered as a very short monopole antenna having a large top-load.)

In the PIFA arrangement described above the transmission lines were short-circuit transmission lines and the circuit elements were capacitors. However, an alternative arrangement is possible in which the transmission lines are open circuit (with a capacitive impedance) and the complementary circuit elements are inductors. Such an arrangement could be formed by modifying the PIFA of FIG. 9 by removing the linking conductor 910 and providing slots in the patch conductor 102, and is shown in FIG. 14. A first slot 1402 starts between the first feed pin 106a and the ground pin 108 and a second slot 1404 starts between the second feed pin 106b and the ground pin 108. Each slot 1402,1404 extends to the edge of the patch conductor, with the length of the slot being chosen to provide a suitable capacitive impedance for matching with an inductor. The slots 1402,1404 may also act to subdivide the PIFA for optimising its dual-band behaviour.

Although an open-circuit arrangement is possible, use of short-circuit transmission lines is still preferred since this enables the use of capacitors as the complementary circuit element. Capacitors generally have a higher Q (typically about 200 at mobile communications frequencies) compared to inductors (typically about 40), and also have better tolerances. Putting the inductance on the antenna substrate (air in the case of a PIFA) means that it can be high quality and used in conjunction with a high quality discrete capacitor. In some cases it may be beneficial to form a capacitor directly on the antenna substrate (for example in the case of an open-circuit transmission line), particularly if the available circuit technology is poor.

Another example of an antenna to which the present invention can be applied is a PWA, a simplified embodiment of which is shown in plan view in FIG. 15. Such an antenna comprises a block 1502 of ceramic material having a conductor pattern 1504 provided on a surface of the block. In practice the shape of the antenna conductor 1504 may be more complex and may extend over more than one surface of the block 1502, but the basic principles are unchanged. One example of a PWA, designed by Philips Components for use in dual-band GSM/DCS applications, has a block 1502 with dimensions 11×17×2 mm. In known PWAs, a single point 1506 on the conductor 1504 is used as a feed point for connection to a dual-band transceiver. However, in a PWA made in accordance with the present invention, the feed arrangement is modified by the addition of first 1512 and second 1514 feed conductors, with respective feed connections 1522,1524, and the central connection 1506 acts as a ground connection. The feed conductors 1512,1514 define respective transmission lines, whose lengths may be individually optimised. As in the PIFA embodiment of FIG. 9, respective shunt capacitors are connected across the first feed connection 1522 and the ground connection 1506 and across the second feed connection 1524 and the ground connection 1506.

In alternative embodiments, one or both of the feed conductors 1512,1514 could remain isolated from the antenna conductor 1504, thereby providing one or two open circuit transmission lines, each of which can be matched using a shunt inductor.

Although the examples described above used two transmission lines having a common ground conductor, it will be apparent that the two transmission lines could have separate ground conductors if desired. Further transmission lines could also be added to provide additional feeds, with additional ground conductors as appropriate.

From the examples presented above it will be clear how the basic idea of the present invention could be applied to driving other monopole-like antennas, including helical antennas.

From reading the present disclosure, other modifications will be apparent to persons skilled in the art. Such modifications may involve other features which are already known in the design, manufacture and use of antenna arrangements and component parts thereof, and which may be used instead of or in addition to features already described herein.

1. A dual-band antenna arrangement comprising an antenna connected to a first feed conductor for signals in a first frequency band, a second feed conductor for signals in a second frequency band and a ground conductor, wherein first and second transmission lines are formed by the ground conductor and a respective one of the feed conductors, and wherein each of the transmission lines has its length optimised to be used in conjunction with a respective complementary circuit element thereby enabling a good match to the antenna to be achieved in each of the frequency bands.

2. An arrangement as claimed in claim 1 wherein the antenna comprises a substantially planar patch conductor, the first feed conductor comprises a first feed pin connected to the patch conductor at a first point, the second feed conductor comprises a second feed pin connected to the patch conductor at a second point, and the ground conductor comprises a ground pin connected between a third point on the patch conductor and a ground plane, wherein the first and second transmission lines are short circuit transmission lines whose respective lengths are defined by a first linking conductor connecting the first feed and ground pins and a second linking conductor connecting the second feed and ground pins, and wherein the complementary circuit elements comprise first and second shunt capacitance means coupled respectively between the first and second feed pins and the ground pin.

3. An arrangement as claimed in claim 2, characterised in that the ground plane is spaced from, and co-extensive with, the patch conductor.

4. An arrangement as claimed in claim 2, characterised in that cross-sectional areas of two of the feed and ground pins are different.

5. An arrangement as claimed in claim 2, characterised in that two ground pins are provided, each forming a transmission line with a respective one of the first and second feed pins.

6. An arrangement as claimed in claim 2, characterised in that at least one of the first and second feed pins and the ground pin comprises a plurality of conductors.

7. An arrangement as claimed in claim 2, characterised in that at least one of the capacitance means comprises a discrete capacitor.

8. An arrangement as claimed in claim 2, characterised in that the upper edge of at least one of the linking conductors is connected to the patch conductor.

9. An arrangement as claimed in claim 2, characterised in that the patch conductor incorporates a slot between one of the first and third points and the second and third points.

10. An arrangement as claimed in claim 1 wherein the antenna comprises a substantially planar patch conductor, the first feed conductor comprises a first feed pin connected to the patch conductor at a first point, the second feed conductor comprises a second feed pin connected to the patch conductor at a second point, and the ground conductor comprises a ground pin connected between a third point on the patch conductor and a ground plane, wherein the first and second transmission lines are open circuit transmission lines whose respective lengths are defined by the lengths of respective slots in the patch conductor extending from between the first and third and the second and third points to the edge of the patch conductor, and wherein the complementary circuit elements comprise first and second shunt inductance means coupled respectively between the first and second feed pins and the ground pin.

11. An arrangement as claimed in claim 1, characterised in that the antenna is one of a printed wire antenna, a helical antenna and a monopole antenna.

12. A radio communications apparatus including an antenna arrangement as claimed in claim 1.
